(19) United States
(12) Patent Application Publication
(10) Pub. No.: US 2017/0363232 A1
(43) Pub. Date: Dec. 21, 2017

(54) Torque Style Union for Joining Conduit and Tool for Use Therewith

(71) Applicant: Howard N. Varnado, Stephenville, TX (US)

(72) Inventor: Howard N. Varnado, Stephenville, TX (US)

(21) Appl. No.: 15/271,921

(22) Filed: Sep. 21, 2016

Related U.S. Application Data
(60) Provisional application No. 62/352,250, filed on Jun. 20, 2016.

(51) Int. Cl. F16L 19/075; B25B 13/50

(52) U.S. Cl. CPC F16L 19/075; B25B 13/50

(57) ABSTRACT

A torque operable conduit union and mating spanner wrench are shown for the hammerless coupling of the ends of abutting fluid conduits, such as pipe, hoses, and fittings. A union nut body has an upper peripheral planar face, a lower peripheral planar face and a circumferential side wall. The circumferential side wall has a series of protuberances extending outwardly therefrom which define at least two circumferentially spaced wrench receiving formations. Each of the wrench receiving formations includes a slot portion which communicates with a transverse opening portion of the formation. The mating spanner wrench has a bridge region which spans certain of the receiving formations and engaging tangs which engage the slot portions of the formations for applying torque to the union nut.

### CROSS REFERENCE TO RELATED APPLICATIONS

The present invention claims priority from a provisional application, Ser. No. 62/352,250, filed Jun. 20, 2016, entitled “Hammerless Union Connection”, by the same inventor.

### BACKGROUND OF THE INVENTION

### Field of the Invention

The present invention relates generally to conduit unions for connecting sections of conduit and to a tool for attaching and removing such unions from conduit connections.

### Description of the Prior Art

Threaded unions, sometimes referred to as “hammer unions”, are used in a variety of industries. In the area of petroleum exploration and production, they are used to join conduits together, for example, conduits containing high-pressure fluids, such as the pipelines used to convey drilling mud, fracturing fluids, and oil and gas produced as a result of drilling activities. Hammer unions have generally been considered to be economical, simple, reliable and robust. A typical example of the traditional hammer union is the WECO™ brand of hammer unions available from FMC Technologies of Houston, Tex. This particular hammer union is merely used to illustrate an example of the type of devices under consideration, there being many other similar commercially available devices at the present time. Typically, hammer unions are used in more temporary situations, for example, for joining together sections of pipe used for pumping fracturing fluids into a well bore under high pressure. However, hammer unions may also be used in certain long-term applications for their ease of make-up and break-out, especially, for example, for equipment that may need to be replaced quickly and efficiently (e.g., rotary hoses for conveying drilling mud between a stand pipe manifold and a rotary swivel or top drive, or components of a choke manifold, such as valves, chokes and spools which may fail unexpectedly due to erosive flows, etc).

Inevitably, in industrial piping systems, plumbing and flow lines systems, the lugs or tangs of the “wing nut” portion of the hammer union will receive variable degrees of visible external damage because of the repeated blows of a sledgehammer that is used against the hammer union to tighten the union. A wing nut with one or more deformed lugs may not be reliably mated with another piece of piping equipment. The piping equipment, however, would generally still be usable if the wing nut is replaced. Currently, when a wing nut becomes deformed due to damaged or deformed lugs, the end of the wing nut pipe segment on which the wing nut is installed is cut off, the deformed wing nut is replaced with a new wing nut, and the pipe is machined and welded together. Unfortunately, this repair approach often has quality problems. These quality problems lead to safety issues. A misaligned wing nut on a hammer union joint may hold pressure for a period of time, but may ultimately fail as the pressure pushes against the joint.

An attempted field repair of a wing nut using common cutting and welding techniques creates a significant risk for misaligned or poorly welded joints. In typical field situations, there may be few or no field personnel qualified to perform the highly skilled welding and machining operations required for a safe repair. Since field repairs may result in significant down time, there is also an economic impact when removing a pipe section to replace a deformed wing nut. In manufacturing and drilling operations, down time directly impacts a company's cost of operations.

The primary reason for wing nut damage is repeated blows from a sledgehammer during the act of tightening the wing nut. As mentioned, connections are made up and broken down by causing the wing nut to turn by repeated blows of heavy hammers, such as sledgehammers with hardened steel heads weighing as much as 20 lbs. that are wielded by hand. This can create a situation where the powerful sledgehammer swings are not correctly directed to the wing nut lugs or tangs, as the user may miss-swing or partially deflect the wing nut tang on a particular swing. This can result in strikes to a lower extremity of the sledgehammer user and can cause potential severe injury to the user. Additionally, the relatively small tangs of the union wing nuts can cause the sledgehammer user to miss the hammer tangs and cause strikes to undesired external surfaces, such as the conduits or surrounding piping. Furthermore, repeated striking of the lugs, tangs or the like of the wing nut can result in metal fatigue, causing the lug to break off and effectively become a dangerous missile.

The use of sledgehammers is among the top causes of job injuries in the oilfield industry. Swinging a hammer or striking or dropping a hammer against one's self or others can cause muscle strains, pinch points, or other physical harm to a worker. Further, conduit, hose, or pipe unions are often assembled or broken down in areas or locations where flammable fumes may permeate the air. Striking the surface of a wing or lug of a union connector, may create sparks which could ignite such flammable fumes creating the potential for explosions and fires that may expose the worker to severe burns or even death as well as extensive property damage to the location.

Another disadvantage of the standard hammer union is the fact that when making such connections with these hammers it is generally impossible to achieve or verify the torque required or desired for effectively mating the components of the threaded portions of the hammer unions. The general forceful over-tightening of the conduit union can inherently create a situation where the user is unable to fully disconnect the connected conduit because of the over-rated force applied during the assembly. This can make the fully-assembled conduit union nearly impossible to remove or to disassemble for common replacement or repositioning purposes. There is also the general lack of quality control considerations, since the user really has no definite idea how much torque has been applied to the connection at hand.

One alternative used in the past for the hammer union was the use of manually operable tongs. These tongs typically have a handle and jaw members that are used grip and turn a nut, swivel, or another threaded connection component of the threaded union. The torque or moment force used to turn the threaded connection components of the threaded union to make up or break out of the threaded joint is created by the force applied to the jaws by tong handle. When the union connection joint is completed, the jaws of the tongs are opened to permit their removal from around the conduit pipe and the threaded union creating the connection joint. Often the moment force or torque applied to the threaded union by the tong jaws is not sufficient to adequately seal the conduit ends together which may result in leaks or cause the conduit to decouple under pressure. Alternatively, the manual tongs may overtighten the connection. Again, the amount of torque applied by the tongs was not typically tracked or recorded.

Consequently, a need exists for an improved fluid conduit union connection and method that will reliably make-up and break-out such a union connection, reduce conduit sealing problems, and reduce the risk of harm for the workers and the risk of damage to the work site location and equipment. The use of such a device will correspondingly enhance worksite safety and reduce the cost and expenses typically associated with the conduit connecting devices and methods currently

A need also exists for an improved conduit union and associated make-up and break-out tool which will have improved capabilities for monitoring and recording the torque applied to each union connection in the pipe line.

Additional objects, features and advantages will be apparent in the written description which follows.

### SUMMARY OF THE INVENTION

In one aspect, the present invention provides a torque style, or “hammerless” union for connecting fluid conduits.

In a further aspect, the present invention provides a union nut and wrench system for use in a hammerless union for connecting first and second conduits.

In a further aspect, the present invention provides a torque style union for connecting first and second conduits wherein the torque applied to make-up the connection can be determined.

In accordance with the above objects, a torque operable union nut is provided, comprising:
a union nut body having an upper peripheral planar face, a lower peripheral planar face and a circumferential side wall connecting the front and rear planar faces, and wherein the circumferential side wall has a series of protuberances extending outwardly therefrom which define at least two circumferentially spaced wrench receiving formations; and
each of said wrench receiving formations comprising a generally arcuate slot portion which communicates with a transverse opening portion of the formation, the slot portions and transverse opening portions of the formations forming a series of radially extending T-shaped beam members when viewed in a plan view.

Preferably, each of the slot portions of the receiving formations forms a pair of oppositely arranged, circumferentially spaced nooks formed at opposite ends of each slot. The receiving formations are selectively sized to receive engaging surfaces of a mating wrench tool, the tool being used to apply torque to the union nut by rotating the union nut. A preferred wrench can be provided wherein the same wrench is engageable with the receiving formations for both making-up and breaking-out the nut from a pipe connection. The preferred union nut is thus hand tightenable with a suitable wrench, without requiring power tongs, or the like.

The present invention also encompasses the combination of a previously described torque operable union nut together with a special spanner wrench for turning the union nut. The preferred spanner wrench has a wrench body having a generally arcuate outer periphery and an interior bridge region, the bridge region terminating at either of two opposite ends with an engagement tang for engaging selected ones of the wrench receiving formations in the union nut body.

The spanner wrench is sized to span at least two of the receiving formations in the union nut body with the engagement tangs of the wrench body being received in selected receiving formations of the union nut body. At least one of the engagement tangs has a foot region which is engaged within one of the pair of oppositely arranged, circumferentially spaced nooks formed at opposite ends of the receiving formation slots.

The spanner wrench body has an upper planar surface, a lower planar surface and a thickness therebetween. A polygonally shaped opening communicates the upper and lower planar surfaces, the polygonally shaped opening being selectively sized to receive an operative member of a torque wrench for applying torque to the spanner wrench and, in turn, to the union nut body. The spanner wrench is preferably provided with an outer peripheral surface which is generally curved in nature and which is designed to deflect the blow of a hammer to discourage use of a hammer in attempting to tighten the union nut.

The combination torque operable union nut and spanner wrench further includes an electronic torque wrench engageable with the polygonally shaped opening in the spanner wrench body for providing an electronic indication of the relative torque being applied by the torque wrench. The preferred electronic torque wrench includes a data storage module which can be used to store and retrieve a history of the torque applied at each pipe connection being made with the union nut and spanner wrench. In some cases, the data storage module is an electronic storage disk which can be removed from the electronic torque wrench and read by a remotely located computer. In other cases, the electronic torque wrench can store and transmit data wirelessly to a remote location for establishing a history of the torque applied at each pipe connection being made with the union nut and spanner wrench.

An improved method is also shown for tightening a torque operable union nut. In the method of the invention, the previously described union nut is threadedly engaged with one of a respective pair of pipe components to be joined in a pipeline, whereby rotating the union nut tightens the pipeline connection. The previously described spanner wrench is then engaged with the selected receiving formations in the union nut body. A suitable torque wrench is then engaged with the polygonally shaped opening in the spanner wrench body and torque is applied to the spanner wrench and, in turn, to the union nut body to turn the union nut body and tighten the union nut. Preferably, the same spanner wrench is used to engage the union nut for both tightening and untightening the union nut.

As previously described, the torque wrench is preferably an electronic torque wrench which is engageable with the polygonally shaped opening in the spanner wrench body for providing an electronic indication of the relative torque being applied by the torque wrench and engaging the electronic torque wrench and recording at least one torque measurement made while tightening the union nut. The electronic torque wrench includes a data storage module which can be used to store and retrieve a history of the torque applied at each pipe connection being made with the union nut and spanner wrench.

These and further features and advantages of the present invention will become apparent from the following detailed description, wherein reference is made to the figures in the accompanying drawings.

### BRIEF DESCRIPTION OF THE DRAWINGS

FIG. 1 is a cross-sectional view of a conventional, prior art hammer union employing a spherical metal-to-metal pressure seal.

FIG. 1A is a perspective view of the wing nut portion of the prior art hammer union of FIG. 1.

FIG. 2 is a view similar to FIG. 1, but showing the torque style union of the invention.

FIG. 3 is a top plan view of one embodiment of the torque style union of the invention shown being engaged by the make-up break-out wrench of the invention.

FIG. 3A is another top plan view, similar to FIG. 3, but showing a smaller spanner wrench engaging the wing nut.

FIG. 4 is a front perspective view of one embodiment of the torque style union of the invention showing the make-up break-out wrench engaging two of the outer slots on the wing nut.

FIG. 5 is an exploded view of an electronic style torque wrench of the type which is used to engage and turn the spanner wrench of the invention.

### DETAILED DESCRIPTION OF THE INVENTION

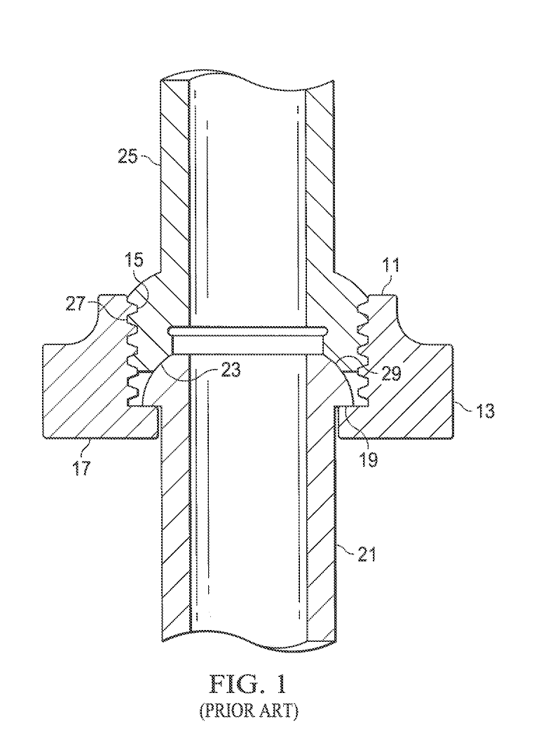

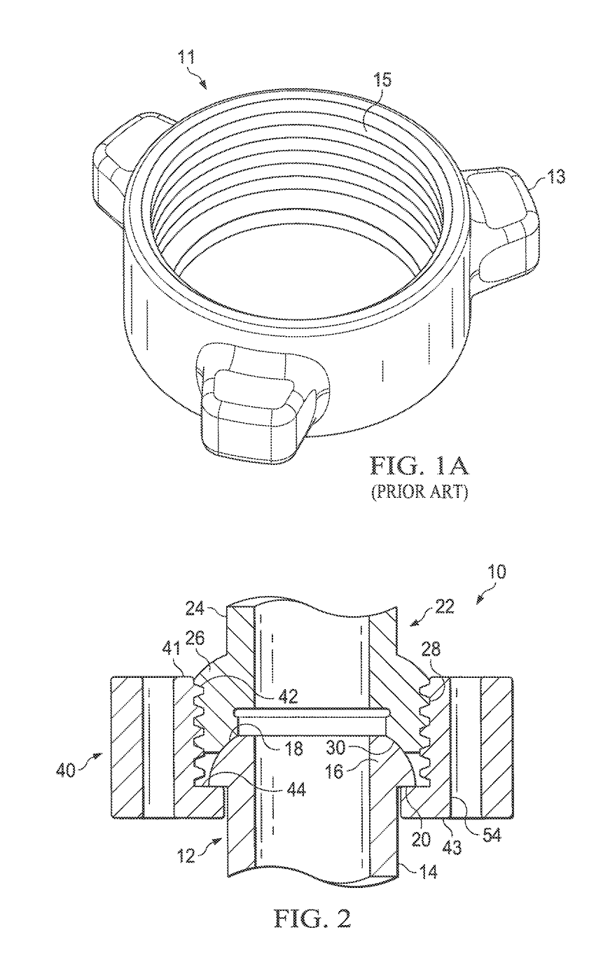

While the invention will be described primarily with reference to the union nut and a tool (wrench) for turning the nut, it will be understood that the hammerless connection of the present invention encompasses not only the union nut and wrench system but suitable male and female subs, e.g. such as described with respect to the prior art assembly shown in FIG. 1. Further it will be understood that in addition to the metal-to-metal sealing shown in the prior art embodiment of FIG. 1, other sealing systems can be employed including elastomeric seals, composite seals, etc.

With reference to FIG. 1, there is shown a cross sectional view of a typical “hammer union” commonly used for joining conduits together, for example, conduit used to convey drilling mud, fracturing fluids and the like, commonly found in oil and gas operations. FIG. 1A shows the same hammer union in perspective. Hammer unions are typically commercially available in, for example, one inch to twelve inch sizes, capable of handling pressures on the order of 1000 psi to as much as 20,000 psi, or more. As shown in FIG. 1, hammer unions typically include three major parts: a shouldered male sub; a threaded union nut; and a threaded female sub. The hammer union is typically made-up or broken out by applying a sledgehammer to radial lugs on the threaded union nut. For example, with reference to FIGS. 1 and 1A, the threaded union nut 11 has hammer lugs 13 which project radially outwardly from nut 11 and which are struck with a sledgehammer to turn and tighten the nut. Union nut 11 also has internal, female threads 15. As seen, union nut 11 has an annular flange 17 which bears on annular shoulder 19 on a distal end of the shouldered male sub 21. A sealing surface 23, in this case a metal-to-metal seal is formed on the end of sub 21. Threaded female sub 25 has external threads 27 which mate with threads 15 and a sealing surface 29 which forms the other half of the metal-to-metal seal with surface 23. It will be understood that other types of pressure seals may be utilized, as well, such as those having elastomeric, or composite seals, especially for (relatively) low working pressure unions.

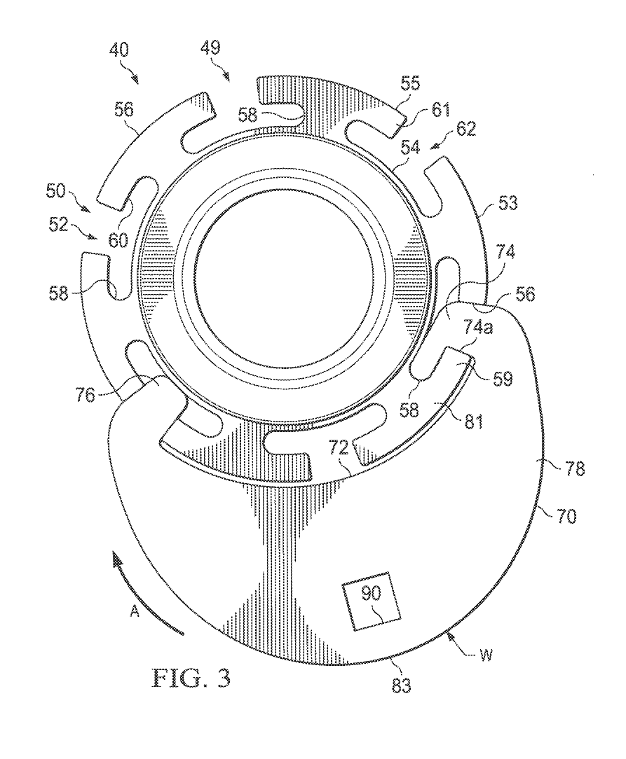

Turning then to FIG. 2, a torque style “hammerless” union of the present invention is shown in cross-section, designated generally as 10. The union of the invention includes a male sub shown generally as 12 comprised of a tubular portion 14 on the end of which is formed an annular, radially outwardly projecting head portion 16. Head portion 16 forms an annular region 18, e.g., a convex surface formed by a spherical segment but which in any event is radiused. Head portion 16 joins the tubular portion 14 to form an annular shoulder 20.

The union connection of the invention also includes a female sub shown generally as 22 which can comprise a tubular portion 24 and an upset portion 26, the upset portion 26 having external threads 28. Upset portion 26 is recessed to form a concave annular seating surface 30 which is complementary in shape to spherical surface 18 such that when surfaces 30 and 18 are in engagement, a metal-to-metal seal can be formed.

Connecting the subs 12 and 22 together is a torque style (hammerless) union nut shown generally as 40 in FIG. 2 and described more fully below. As can be seen, union nut 40 has internal threads 42 which threadedly engage external threads 28 on sub 22 when the connection is made-up. Union nut 40 also has an annular, radially inwardly extending lip portion 44. Union nut 40 has an upper peripheral planar face 41, a lower peripheral planar face 43, and a circumferential outer side wall 54. Union nut 40 also has a through bore that is provided with internal female threads 42 in surrounding relationship to the through bore. As shown in FIG. 2, in the fully made-up position, i.e., when union nut 40 is threaded onto threaded upset portion 26, lip portion 44 of union nut 40 is forced into engagement with shoulder 20 of male sub 12 forcing surfaces 30 and 18 into metal-to-metal sealing engagement with each other.

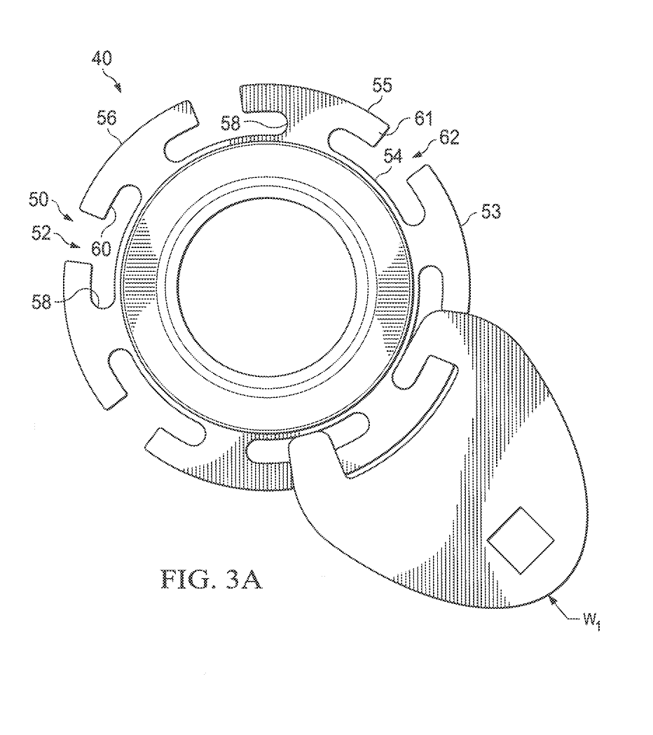

As perhaps can be best appreciated from FIG. 3, the peripheral outer side wall 54 of the union nut 40 has a series of T-shaped beam members or protuberances (such as protuberances 53, 55, 56) extending radially outwardly therefrom which define at least two circumferentially spaced, inwardly extending wrench receiving formations. One such wrench receiving formation is indicated at 49 in FIG. 3. Each of the wrench receiving formations further comprises a series of generally circumferentially extending, arcuate slots 52 which communicates with a transverse opening portion 50 (see FIG. 3). Accordingly, there are funned first and second nooks or recesses 58 and 60 located at the terminal ends of each slot.

It can thus be seen from FIG. 3 that each of the pairs of oppositely arranged, circumferentially spaced nooks 58 and 60, the outer peripheral surface 54 of union nut 40, and transverse openings 50 comprise the wrench receiving formations for receiving mating engagement portions of a It cooperating spanner wrench, to be further described.

In order to thread nut 40 onto female sub 22, a wrench shown generally as “W” in FIG. 3 is employed. In the embodiment shown in FIG. 3, the spanner wrench W has a wrench body having a curved outer periphery 70. In the embodiment shown in FIG. 3, the outer periphery is generally arcuate shaped. The wrench body also has an interior bridge region 72. The bridge region 72 terminates at either of two opposite ends with an engagement tang, i.e., tangs 74, 76, for engaging selected ones of the wrench receiving formations in the union nut body. The spanner wrench W is sized to span at least two of the receiving formations in the union nut body with the engagement tangs 74, 76, of the wrench body being received in selected receiving formations of the union but body, at least one of the engagement tangs 74, 76 being engaged within one of the pair of oppositely arranged, circumferentially spaced nooks (such as nooks 58, 60 in FIG. 3) formed at opposite ends of the receiving formation slots. In the embodiment shown in FIG. 3, the spanner wrench W actually spans three of the receiving formations.

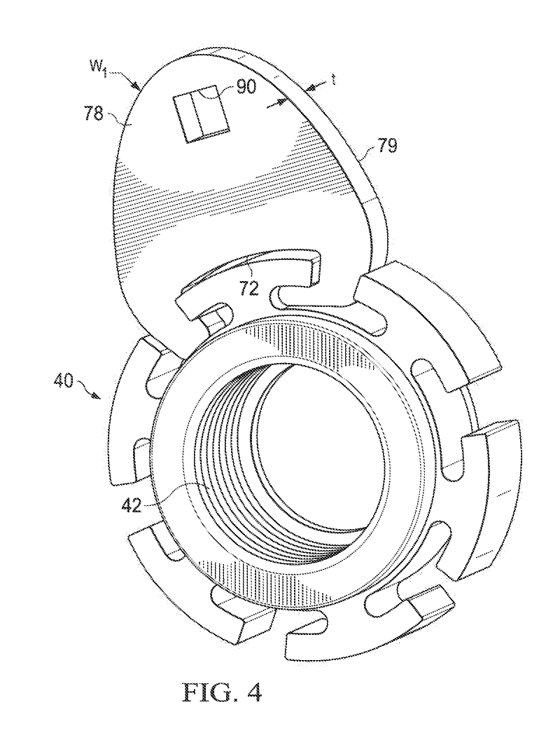

The spanner wrench body has an upper planar surface 78, a lower planar surface 79 and a thickness “t” therebetween (see FIG. 4). A polygonally shaped opening 90 communicates the upper and lower planar surfaces 78, 79. The polygonally shaped opening is selectively sized to receive an operative end of a torque wrench for applying torque to the spanner wrench and, in turn, to the union nut body.

With reference again to FIG. 3, the tang 74 of the wrench forms an U-shaped head portion the most distal portion of which forms a laterally extending foot 58. The distal end of the opposite tang 76 is truncated, since this is the low pressure side of the connection in the position shown. Thus, as wrench W engages union nut 40 as shown in FIG. 3, U-shaped end portion 74 will engage the respective receiving formation designated, while the opposite tang 76 will engage one of the other circumferentially spaced receiving formations. Note again that, with respect to FIG. 4, the wrench will span at least two of the receiving openings, but as shown in FIG. 3, may span three or more openings. The relatively smaller style spanner wrench shown in FIG. 3A is designated as “W₁.”

It will be appreciated that in the position shown in FIG. 3, wrench W will be moved in the direction of arrow A. Thus, end portion 74 of wrench W is being forced against one end of beam 81 associated with one of the receiving formations. As well, end portion 76 is forced generally radially inwardly such that its distal end contacts the inner peripheral sidewall 54 of the union nut. Thus there will be substantial force vectors tending to rotate nut 40 in the direction of arrow A. Assuming this direction of turn, i.e., that of arrow A shown in FIG. 3 would result in tightening of nut 40 and accordingly make-up of the union, it will be recognized that if it were desired to break-out the union, i.e., loosen nut 40, wrench W could be flipped over and inverted oppositely to the position shown in FIG. 3 (see FIG. 4). This is an important feature, since the same wrench W is engageable with the existing receiving formations for both making-up and breaking-out the nut from a pipe connection. It is also significant to note that the union nut is hand tightenable with the wrench W, and does not typically require a power tong, or the like.

Several other features of the union nut/wrench combination of the present invention are important. For one, wrench W can only engage nut 40 by movement of the bridge region 72 and tangs 74, 76 into the receiving formations by insertion from an axial direction with respect to the pipe. In other words, engagement by wrench W of nut 40 cannot be accomplished by relative movement of wrench W and nut 40 in a straight-in radial direction, as viewed in FIG. 3, Further, as will be appreciated from FIG. 3, once wrench W is fully engaged with nut 40, wrench W cannot be disengaged from nut 40 by straight radial outward movement of wrench W relative to nut 40. This ensures that when nut 40 is being tightened or loosened by wrench W, wrench W cannot disengage from nut 40 by radial outward movement. It will be appreciated that the shapes of the receiving formations of nut 40 and the shape of head portion of bridge 72 of wrench W can vary. Thus, the shapes shown in the figures are exemplifying several embodiments but the invention is not so limited. Note that the outer peripheral surface (designated as 83 in FIG. 3) is arcuate shaped, or somewhat rounded. This ensures that there is no convenient point for a hammer to be applied to the wrench by an uninformed user.

Another important feature of the nut/wrench combination of the present invention, is that when the nut 40 is being moved, whether it be to tighten or loosen nut 40, there are significant circumferential force vectors being applied by wrench W to nut 40.

With regard to the type of torque wrench used to engage the polygonally shaped opening 90 of the wrench to apply torque, any of a variety of types of commercially available wrenches can be employed. For example, beam and dial systems can be employed. However, easier to use mechanical systems such as click or toggle torque wrench measuring devices are more preferred. In addition to purely mechanical torque measuring systems, electronic torque determinations based on strain gauges, and the like, can also be employed, Many of these systems can include electronic read-out either via a tethered connection to a portable controller or wirelessly to a remote unit.

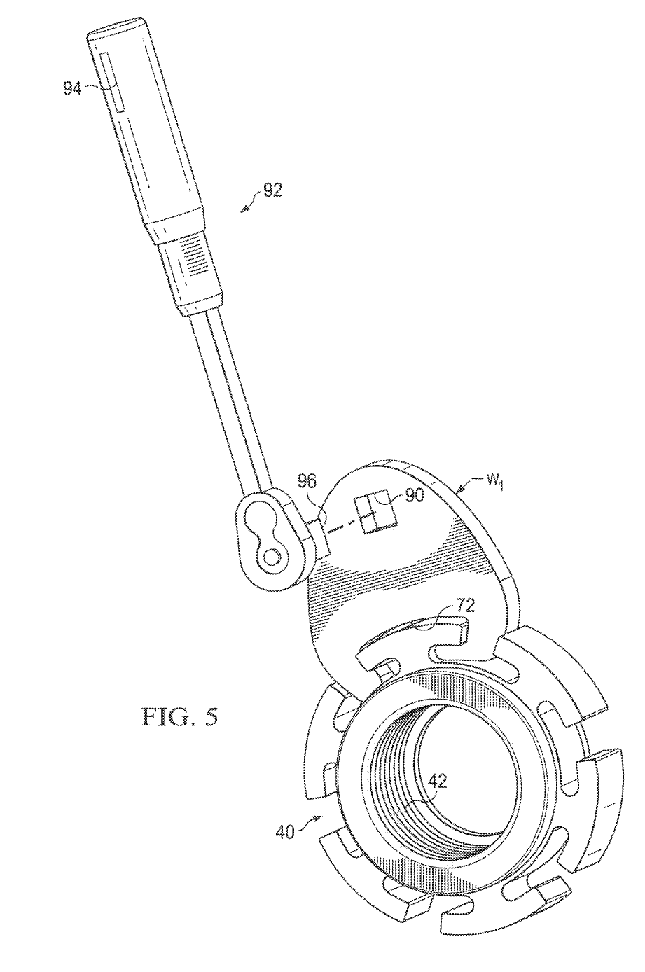

Thus, in a further embodiment, the wrench W of the present invention can be provided with an electronic torque measuring device, shown in simplified fashion as 92 in FIG. 5. A number of such devices are commercially available, For example, DMC Corporation of Orlando, Fla., sells the “Angle USB Electronic Digital Torque Wrench” at the present time. It has a drive member 96 for engaging the opening in the spanner wrench, and an onboard memory, illustrated schematically as 94 in FIG. 5, which can upload and download information from a personal computer by means of a built-in USB port. This particular device is merely given by way of illustration, as a number of equivalent devices are commercially available at the present time.

With an electronic torque measuring device of this type, an on-board data module can be used to store and retrieve a history of the torque applied at each pipe connection being made with the union nut and spanner wrench. In some instances it is envisioned that the data storage module will incorporate an electronic storage disk (Scandisk™ or the like) which can be removed from the electronic torque wrench and read by a remotely located computer. In another embodiment, the electronic torque wrench can store and transmit data wirelessly to a remote location for establishing a history of the torque applied at each pipe connection being made with the union nut and spanner wrench.

Although specific embodiments of the invention have been described herein in some detail, this has been done solely for the purposes of explaining the various aspects of the invention, and is not intended to limit the scope of the invention as defined in the claims which follow. Those skilled in the art will understand that the embodiment shown and described is exemplary, and various other substitutions, alterations and modifications, including but not limited to those design alternatives specifically discussed herein, may be made in the practice of the invention without departing from its scope.

Thus, while the invention has been shown in several of its forms, it is not thus limited but is susceptible to various changes and modifications without departing from the spirit thereof.

What is claimed is:

1. A torque operable union nut, comprising:
a union nut body having an upper peripheral planar face, a lower peripheral planar face and a circumferential side wall connecting the upper and lower planar faces, and wherein the circumferential side wall has a series of protuberances extending outwardly therefrom which define at least two circumferentially spaced wrench receiving formations;
each of said wrench receiving formations comprising a slot portion which communicates with a transverse opening portion of the formation, the slot portions and transverse opening portions of the formations forming a series of circumferentially extending beam members when viewed in a plan view.

2. The torque operable union nut of claim 1, wherein each of the slot portions of the receiving formations forms a pair of oppositely arranged, circumferentially spaced nooks formed at opposite ends of each slot.

3. The torque operable union nut of claim 2, wherein the receiving formations are selectively sized to receive engaging surfaces of a mating wrench tool, the tool being used to apply torque to the union nut by rotating the union nut.

4. The torque operable union nut of claim 3, wherein the same wrench is engageable with the receiving formations for both making-up and breaking-out the nut from a pipe connection.

5. The torque operable union nut of claim 4, wherein the union nut is hand tightenable with a suitable wrench.

6. In combination, a torque operable union nut and spanner wrench, the combination comprising:
a union nut body having an upper peripheral planar face, a lower peripheral planar face and a circumferential side wall connecting the upper and lower planar faces, and wherein the circumferential side wall has a series of protuberances extending outwardly therefrom which define at least two circumferentially spaced wrench receiving formations;
each of said wrench receiving formations comprising a generally arcuate slot portion which communicates with a transverse opening portion of the formation, each of the slot portions of the receiving formations forming a pair of oppositely arranged, circumferentially spaced nooks formed at opposite ends of each slot, the slot portions and transverse opening portions of the formations further forming a series of circumferentially extending T-shaped beam members when viewed in a plan view; and
a spanner wrench, the spanner wrench having wrench body having a generally arcuate outer periphery and an interior bridge regions, the bridge region terminating at either of two opposite ends with an engagement tang for engaging the wrench receiving formations in the union nut body.

7. combination torque operable union nut and spanner wrench of claim 6, wherein the spanner wrench is sized to span at least two of the receiving formations in the union nut body with the engagement tangs of the wrench body being received in selected receiving formations of the union but body, at least one of the engagement tangs being engaged within one of the pair of oppositely arranged, circumferentially spaced nooks formed at opposite ends of the receiving formation slots.

8. The combination torque operable union nut and spanner wrench of claim 7, wherein the spanner wrench body has an upper planar surface, a lower planar surface and a thickness therebetween, and wherein a polygonally shaped opening communicates the upper and lower planar surfaces, the polygonally shaped opening being selectively sized to receive an operative end of a torque wrench for applying torque to the spanner wrench and, in turn, to the union nut body.

9. The combination torque operable union nut and spanner wrench of claim 8, wherein the combination further includes an electronic torque wrench engageable with the polygonally shaped opening in the spanner wrench body for providing an electronic indication of the relative torque being applied by the torque wrench.

10. The combination torque operable union nut and spanner wrench of claim 9, wherein the electronic torque wrench includes a data storage module which can be used to store and retrieve a history of the torque applied at each pipe connection being made with the union nut and spanner wrench.

11. combination torque operable union nut and spanner wrench of claim 10, wherein the data storage module is an electronic storage disk which can be removed from the electronic torque wrench and read by a remotely located computer.

12. The combination torque operable union nut and spanner wrench of claim 10, wherein the electronic torque wrench can store and transmit data wirelessly to a remote location for establishing a history of the torque applied at each pipe connection being made with the union nut and spanner wrench.

13. A method of tightening a torque operable union nut, the method comprising the steps of:
a union nut body having an upper peripheral planar face, a lower peripheral planar face and a circumferential side wall connecting the upper and lower planar faces, and wherein the circumferential side wall has a series of protuberances extending outwardly therefrom which define at least two circumferentially spaced wrench receiving formations;
wherein each of said wrench receiving formations comprises a generally arcuate slot portion which communicates with a transverse opening portion of the formation, each of the slot portions of the receiving formations forming a pair of oppositely arranged, circumferentially spaced nooks formed at opposite ends of each slot, the slot portions and transverse opening portions of the formations further funning a series of circumferentially extending T-shaped beam members when viewed in a plan view;
threadedly engaging the union nut with one of a respective pair of pipe components to be joined in a pipeline, whereby rotating the union nut tightens the pipeline connection;
providing a spanner wrench for tightening the union nut, the spanner wrench having a wrench body with a curved outer periphery and an interior bridge region, the bridge region terminating at either of two opposite ends with an engagement tang for engaging the wrench receiving formations in the union nut body, the spanner wrench body having an upper planar surface, a lower planar surface and a thickness therebetween, and wherein a polygonally shaped opening communicates the upper and lower planar surfaces;
engaging a suitable torque wrench with the polygonally shaped opening in the spanner wrench body and applying torque to the spanner wrench and, in turn, to the union nut body to turn the union nut body and tighten the union nut.

14. The method of claim 13, wherein the same spanner wrench is used to engage the union nut for untightening the union nut.

15. The method of claim 13, wherein the spanner wrench has an outer peripheral surface which is arcuate in nature and which is designed to deflect the blow of a hammer to discourage use of a hammer in attempting to tighten the union nut,

16. The method of claim 13, further comprising the steps of providing an electronic torque wrench engageable with the polygonally shaped opening in the spanner wrench body for providing an electronic indication of the relative torque being applied by the torque wrench and engaging the electronic torque wrench and recording at least one torque measurement made while tightening the union nut.

17. The method of claim 16, wherein the electronic torque wrench includes a data storage module which can be used to store and retrieve a history of the torque applied at each pipe connection being made with the union nut and spanner wrench.

18. The method of claim 17, wherein the data storage module is an electronic storage disk which can be removed from the electronic torque wrench and read by a remotely located computer.

19. The method of claim 17, wherein the electronic torque wrench can store and transmit data wirelessly to a remote location for establishing a history of the torque applied at each pipe connection being made with the union nut and spanner wrench.
